(19) United States
(12) Patent Application Publication
(10) Pub. No.: US 2015/0137927 A1
(43) Pub. Date: May 21, 2015

(54) TRANSFORMER SKELETON AND A WINDING METHOD USING THE SAME

(71) Applicant: DELTA ELECTRONICS (JIANGSU) LTD., Wujiang City (CN)

(72) Inventors: Song LUO, Wujiang City (CN); Xiao-Xia YUAN, Wujiang City (CN); Shao-Dong ZHANG, Wujiang City (CN)

(21) Appl. No.: 14/332,941

(22) Filed: Jul. 16, 2014

(30) Foreign Application Priority Data
Nov. 20, 2013 (CN) 201310583157.7

(51) Int. Cl. H01F 27/28; H01F 41/06

(52) U.S. Cl. CPC H01F 27/2823; H01F 41/0612
USPC 336/192; 336/208; 29/605

(57) ABSTRACT

A transformer skeleton and a winding method using the same are provided. The transformer skeleton includes at least one limiting hook. The limiting hook and a pin of the transformer skeleton are located on a same side of the transformer skeleton. A wire, which is led out from a winding groove of the transformer skeleton, electrically contacts the pin and passes through the limiting hook. The limiting hook is used to prevent the wire from moving upward. The advantage of the transformer skeleton is that the transformer skeleton disposes at least one limiting hook which is used to prevent the wire from moving upward and only a single layer of the wire contacts the pin in order to reduce the height of a tin cone. The transformer skeleton can decrease the height of the tin cone by 70%˜80%, thereby efficiently decreasing the height and width of the transformer.

### BACKGROUND OF THE INVENTION

1. Field of the Invention

The present invention relates to the field of electronic products, and more particularly to a transformer skeleton and a winding method using the same.

2. Description of the Prior Art

With the development of electronic products, thin and small electronic products are favored by user. A transformer as one important part of a power is also asked to be thinning and miniaturization. In other words, length and width of the transformer need to become smaller.

In the prior art, a winding wire of the transformer needs to be twined around a pin or a side pin and then soldered, thereby ensuring the electrical conduction of the transformer. FIG. 1 shows the winding wire of the transformer 1 twined on the pin in the prior art. Referring to FIG. 1, the winding wire 10 of the transformer 1 is twined on the pin 11. In the subsequent process, it is necessary to solder the winding wire 10 onto the pin 11 to ensure the electrical connection of the transformer.

In the prior art, twining the winding wire 10 on the pin 11 or the side pin has several disadvantages. The winding wire 10 could move upward. Also, the solder on the winding wire 10 and the pin 11 or on the winding wire 10 and the side pins will necessarily form a tin cone. The moving upward of the winding wire 10 could further cause the volume of the tin cone to increase. Since the volume of the tin cone and the movement height of the winding wire 10 will be included in the height of the transformer, it is necessary to increase the height and the width of the space to accommodate the larger transformer needed in order to ensure the safe assembly of the transformer and a circuit board, and to avoid direct contact between the tin cone and the circuit board. However, this will result in a larger transformer, so the prior structure limits the thinning and miniaturization of the electrical product.

### BRIEF SUMMARY OF THE INVENTION

One object of the present invention is to solve the above problems, and to provide a transformer skeleton and a winding method using the same, which can prevent a wire from moving upward and can control the height of a tin cone produced in a soldering process, thereby reducing the height and width of a transformer.

To solve the above problems, the present invention provides a transformer skeleton, comprising at least one limiting hook. The limiting hook and a pin of the transformer skeleton are located on a same side of the transformer skeleton. A wire, which is led out from a winding groove of the transformer skeleton, electrically contacts the pin and passes through the limiting hook. The limiting hook is used to prevent the wire from moving upward.

Further, the limiting hook and the pin are in a staggered arrangement.

Further, a terminal portion of the limiting hook has a bending structure thereon, one end of which is connected with the transformer skeleton. The bending structure and the transformer skeleton together define a position-limited space, and the position-limited space allows the wire to pass through.

Further, the height of the position-limited space is equal to the diameter of the wire for fixing the wire.

Further, the transformer skeleton further comprises a recess, wherein the recess and the pin are respectively located on two opposite sides of the limiting hook, and the wire is cut in the recess after passing through the limiting hook.

Further, the limiting hook is made of a plastic material.

To solve the above problems, the present invention also provides a winding method using a transformer skeleton, comprising the following steps of:

Leading out a wire from a winding groove of the transformer skeleton to a pin of the transformer skeleton and forming an electric contact between the wire and the pin; and

Passing the wire pass through the pin and a limiting hook disposed on the transformer skeleton, wherein the limiting hook is used to prevent the wire from moving upward and ensure an electric contact of the wire and the pin.

Further, the winding method further comprises the step of cutting the wire in a recess, which is located on an opposite side of the limiting hook relative to the pin, after passing through the limiting hook.

The advantage of the transformer skeleton of the prevent invention is that the transformer skeleton disposes at least one limiting hook, which is located on the same side as the pin. The limiting hook is used to prevent the moving upward of the wire, which electrically contacts the pin. Only a single layer of the wire contacts the pin, which reduces the height of the tin cone produced during a soldering process. The transformer skeleton of the present invention can decrease the tin cone height by 70%˜80%, thereby efficiently decreasing the height and width of the transformer.

### BRIEF DESCRIPTION OF THE DRAWINGS

FIG. 1 is a schematic view of a transformer and a winding mode thereof in the prior art;

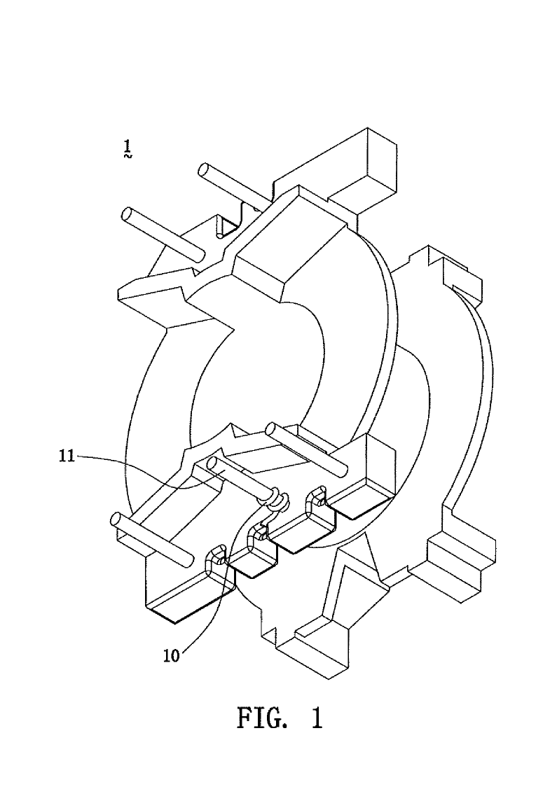

FIG. 2 is a structure schematic view of one transformer skeleton of the present invention;

FIG. 3 is a structure schematic view of another transformer skeleton of the present invention; and

FIG. 4 is a flow chart of a winding method of the present invention.

The reference numerals in the drawings are described as follows:
1 transformer
10 winding wire
11 pin
2 transformer skeleton
21 limiting hook
22 pin
23 bending structure
24 position-limited space
25 winding groove
26 wire
27 recess

### DETAILED DESCRIPTION OF THE PREFERRED EMBODIMENTS

The following detailed description of the preferred embodiments of the present invention is with reference to the accompanying drawings.

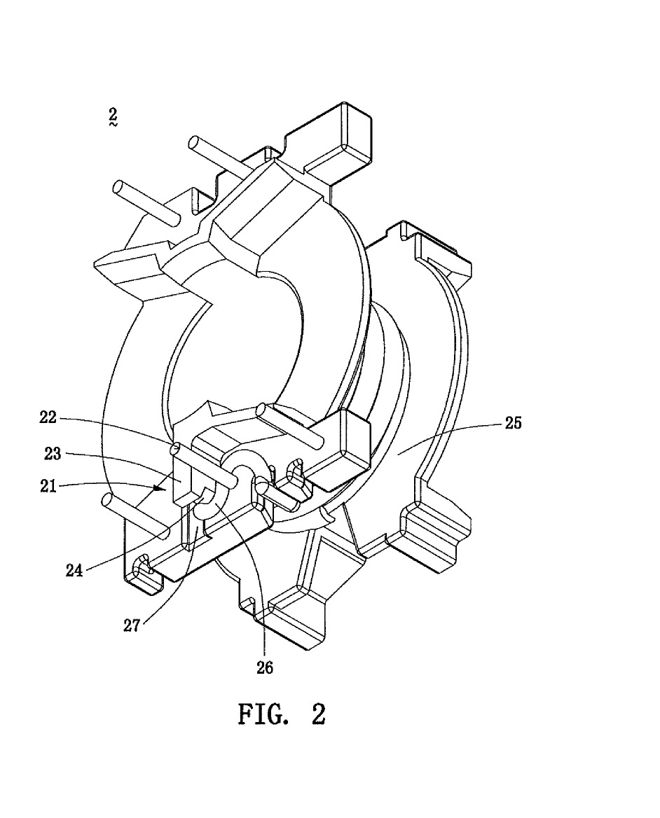

Please refer to FIG. 2, which shows a transformer skeleton 2 of the present invention. The transformer skeleton 2 includes at least one limiting hook 21. The limiting hook 21 and a pin 22 of the transformer skeleton 2 are located on a same side of the transformer skeleton 2. In a specific embodiment, the transformer skeleton 2 has one limiting hook 21. When the pin 22 is located on a terminal portion of the transformer skeleton 2, the limiting hook 21 is also located on the terminal portion of the transformer skeleton 2. A wire 26 coming from a winding groove 25 directly and electrically contacts the pin 22, and then the wire 26 passes through the limiting hook 21, which is used to prevent the wire 26 from moving upward.

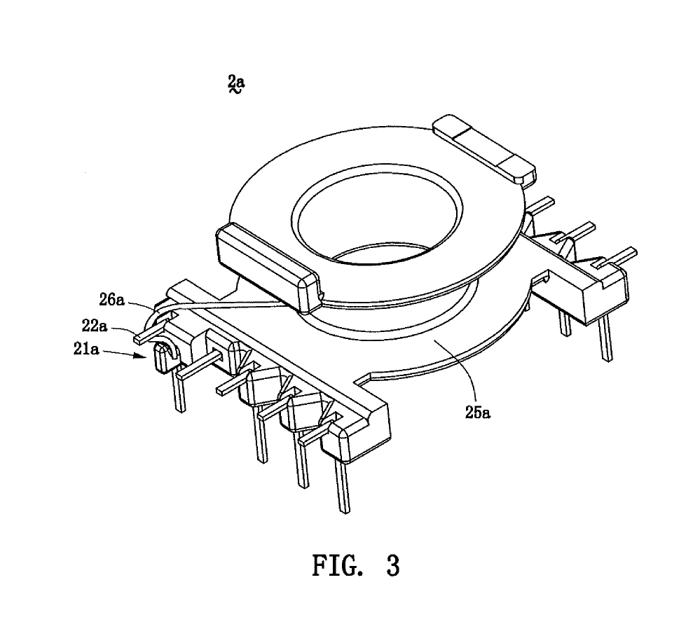

Please refer to FIG. 3, which shows a transformer 2a skeleton of the present invention. The transformer skeleton is indicated by reference numeral 2a. The components of FIG. 3, such as the limiting hook 21a, the pin 22a, the winding groove 25a and the wire 26a, which are analogous to components of FIG. 2, share the same reference numeral with the addition of the suffix “a”. In the second embodiment, which is shown in FIG. 3, the wire 26a is let out from the winding groove 25a to directly and electrically contact the pin 22a, and then the wire 26a passes through the limiting hook 21a. The difference between the transformer skeleton 2a of the second embodiment and the transformer skeleton 2 of the first embodiment is that: the pin 22a is located on a side surface of the transformer skeleton 2a. That is, the pin 22a is a side pin, and the limiting hook 21a is located on the side surface of the transformer skeleton 2a.

Please refer again to FIG. 2, the limiting hook 21 and the pin 22 are in a staggered arrangement. The wire 26 is led out from the winding groove 25 of the transformer skeleton 2, and passes through the pin 22 and the limiting hook 21. The pin 22 and the limiting hook 21 can apply two contrary forces onto the wire 26, so that the wire 26 not only can electrically contact the pin 22, but also can pass through the limiting hook 21 to be prevented from moving upward.

Please refer to FIG. 2, the electric contact between the wire 26 led out from the winding groove 25 of the transformer skeleton 2 and the pin 22 means that the wire 26 and the pin 22 have only contact once. Namely, only a single layer of the wire 26 contacts the pin 22, thereby forming the electric connection between the winding wire of the transformer and an external device. The wire 26 does not twine on the pin 22. If the wire 26 twines on the pin 22, it will cause too much wire 26 to accumulate on a soldering portion of the pin 22 and cause a tin cone of the solder too high. The wire 26 only contacts the pin 22 once and does not twine on the pin 22, so that the height of the tin cone of the solder could not be too high and the height of the transformer also could not be too high after soldering. Therefore, the present invention can reduce the size of the transformer.

Please refer to FIG. 2, the limiting hook 21 has a bending structure 23 on a terminal portion thereof. The bending structure 23 is in an L shape or a U shape, one end or two ends of which are connected with the transformer skeleton 2 to form a position-limited space 24. The position-limited space 24 allows the wire 26 to pass through. In this specific embodiment, one end of the bending structure 23 is connected with the transformer skeleton 2. The wire 26, which contacts the pin 22, passes through the position-limited space 24 and is limited within the position-limited space 24, so that wire 26 cannot move upward and cannot be separated from the contact with the pin 22. This will be convenient for a subsequent soldering process. Further, the height of the position-limited space 24 is equal to the diameter of the wire 26, so the position-limited space 24 can fix the wire 26. This will be more convenient for a subsequent soldering process.

Further, in this specific embodiment, the transformer skeleton 2 also includes a recess 27. The recess 27 and the pin 22 are respectively located on two opposite sides of the limiting hook 21. The wire 26, after passing through the limiting hook 21, will be cut in the recess 27. It is convenient to cut the wire 26 in the recess 27, so that a surface of the transformer skeleton 2 will not be damaged when cutting the wire 26.

The limiting hook 21 may be made of a plastic material, thereby avoiding an electric connection between the wire 26 and the limiting hook 21.

In the transformer skeleton 2 of the present invention, the limiting hook 21 is used to prevent the wire 26 from moving upward. Each pin 22 needing to contact the wire 26 needs to be equipped with one limiting hook 21, thereby reducing the height and width of the transformer. The transformer skeleton 2 of the present invention can decrease the height of the tin cone by 70%˜80%, thereby efficiently decreasing the height and width of a transformer employing the transformer skeleton.

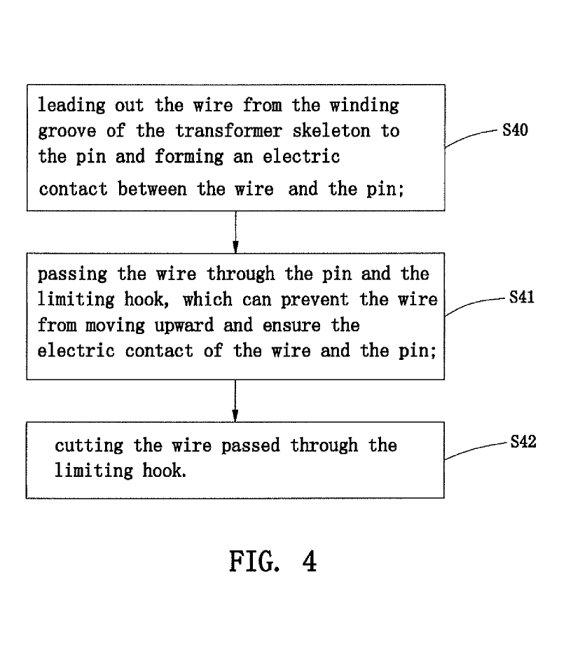

The present invention also provides a winding method using the above transformer skeleton 2. Referring to FIG. 4, the winding method includes the following steps: a step S40 leading out the wire 26 from the winding groove 25 of the transformer skeleton 2 to the pin 22 and forming an electric contact between the wire 26 and the pin 22; a step S41 passing the wire 26 through the pin 22 and the limiting hook 21, which can prevent the wire 26 from moving upward and ensure the electric contact of the wire 26 and the pin 22; and a step S42 cutting the wire 26 after passing through the limiting hook 21.

In step S40, the wire 26 is led out from the winding groove 25 of the transformer skeleton 2 to the pin 22 and forms an electric contact with the pin 22. The electric contact between the wire 26 and the pin 22 means that the wire 26 and the pin 22 have only one contact to realize the electric connection of the winding wire of the transformer and an external device. The wire 26 does not twine on the pin 22. If the wire 26 twines on the pin 22, it will cause too much wire 26 to accumulate on a soldering portion of the pin 22 and cause a tin cone of the solder too high. The wire 26 only contacts the pin 22 once and does not twine on the pin 22, so that the height of the tin cone of the solder could not be too high and the height of the transformer also could not be too high after soldering. Therefore, the present invention can reduce the size of the transformer.

In step S41, the wire 26 passes through the pin 22 and the limiting hook 21, and the limiting hook 21 can prevent the wire 26 from moving upward.

In step S41, the limiting hook 21 and the pin 22 are arranged in a staggered mode. The wire 26 passes through the pin 22 and the limiting hook 21 after the wire 26 is led out from the winding groove 25 of the transformer skeleton 2. Two contrary forces are applied onto the wire 26 by the pin 22 and the limiting hook 21, so that the wire 26 not only can electrically contact the pin 22, but also can pass through the limiting hook 21 to be prevented from moving upward.

In step S41, a terminal portion of the limiting hook 21 has a bending structure 23 thereon, one end or two ends of which are connected with the transformer skeleton 2. The bending structure 23 and the transformer skeleton 2 together define a position-limited space 24. The position-limited space 24 allows the wire 26 to pass through. In this specific embodiment, one end of the bending structure 23 is connected with the transformer skeleton 2. The wire 26, which contacts the pin 22, passes through the position-limited space 24 and is limited within the position-limited space 24, so that the wire 26 cannot move upward and cannot be separated from the contact with the pin 22. This will be convenient for a subsequent soldering process. Further, the height of the position-limited space 24 is equal to the diameter of the wire 26 in order to be able to fix the wire 26. This will be more favored for a subsequent soldering process.

In step S42, the wire 26 is cut after passing through the limiting hook 21.

In step S42, the transformer skeleton 2 also includes a recess 27, which is located on an opposite side of the limiting hook 21 relative to the pin 22. The wire 26 can be cut in the recess 27 after passing through the limiting hook 21. Cutting the wire 26 in the recess 27 is convenient, so a surface of the transformer skeleton 2 will not be damaged when cutting the wire 26.

In conclusion, although the present invention has been disclosed by above preferred embodiments, above preferred embodiments are not used to limit the present invention. One of ordinary skills in the art also can make all sorts of improvements and amendments within the principles of the present invention. Therefore, the protection scope of the present invention should be based on the scope defined by the appended claims.

What is claimed is:

1. A transformer skeleton, comprising at least one limiting hook, wherein the limiting hook and a pin of the transformer skeleton being located on a same side of the transformer skeleton; a wire, which is led out from a winding groove of the transformer skeleton, electrically contacting with the pin and passing through the limiting hook; and the limiting hook being used to prevent the wire from moving upward.

2. The transformer skeleton as claimed in claim 1, wherein the limiting hook and the pin are in a staggered arrangement.

3. The transformer skeleton as claimed in claim 1, wherein a terminal portion of the limiting hook has a bending structure thereon, one end of which is connected with the transformer skeleton; the bending structure and the transformer skeleton together define a position-limited space; and the position-limited space allows the wire to pass through.

4. The transformer skeleton as claimed in claim 3, wherein the height of the position-limited space is equal to the diameter of the wire for fixing the wire.

5. The transformer skeleton as claimed in claim 2, further comprising a recess, wherein the recess and the pin are respectively located on two opposite sides of the limiting hook, and the wire is cut in the recess after passing through the limiting hook.

6. The transformer skeleton as claimed in claim 1, wherein the limiting hook is made of a plastic material.

7. A winding method using a transformer skeleton, comprising the following steps of:
leading out a wire from a winding groove of the transformer skeleton to a pin of the transformer skeleton and forming an electric contact between the wire and the pin; and
passing the wire through the pin and a limiting hook disposed on the transformer skeleton, wherein the limiting hook is used to prevent the wire from moving upward and ensure an electric contact between the wire and the pin.

8. The winding method as claimed in claim 7, wherein the transformer skeleton comprises a recess, which is located on an opposite side of the limiting hook relative to the pin; and the winding method further comprising the following step of:
cutting the wire in the recess after passing through the limiting hook.
